(19) United States
(12) Patent Application Publication
(10) Pub. No.: US 2026/0367423 A1
(43) Pub. Date: Nov. 19, 2026

(54) VISUAL SYSTEM

(71) Applicant: ZHEJIANG SUNNY OPTICS CO., LTD., Yuyao City (CN)

(72) Inventors: Linwei WU, Yuyao City (CN); Xiaobin ZHANG, Yuyao City (CN); Chengli GUO, Yuyao City (CN)

(73) Assignee: ZHEJIANG SUNNY OPTICS CO., LTD., Yuyao City (CN)

(21) Appl. No.: 19/420,059

(22) Filed: Dec. 15, 2025

(30) Foreign Application Priority Data
May 19, 2025 (CN) 202510649010.6

(51) Int. Cl. G02C 7/08; G02B 15/14; G02B 27/00; G02B 27/01

(52) U.S. Cl. CPC G02C 7/081; G02B 15/1421; G02B 27/0018; G02B 27/0172; G02B 2027/011; G02B 2027/0116

(57) ABSTRACT

A visual system includes: a first element group comprising a first lens, a polarizer, a reflective polarizing element, and a quarter-wave plate; and a second element group being movable along a direction of an optical axis, and comprising a second lens, a partially reflective element, and a display; wherein a center thickness CT2 of the second lens on the optical axis and an amount of change Δf in the effective focal length of the visual system when moving from the +2D state to the −5D state satisfy: 1.59≤CT2/Δf≤2.19. The present disclosure solves the problem in the prior art that it is difficult to simultaneously achieve a large diopter adjustment range and stable imaging quality in a visual system.

### CROSS-REFERENCE TO RELATED APPLICATIONS

The present application claims the priority of Chinese patent application No. 202510649010.6, filed on May 19, 2025, which is hereby incorporated by reference in its entirety.

### TECHNICAL FIELD

The present disclosure relates to the technical field of head-mounted display devices, and specifically to a visual system.

### BACKGROUND

Among the existing Folded-Optics VR Head-Mounted Displays, there are few products designed for special groups of people (myopia/hyperopia/strabismus/excessively wide or narrow pupil distance). To meet a wide range of diopter adjustment, the movement range of optical assemblies is relatively larger. This excessive displacement of the optical assemblies during diopter adjustment significantly impacts the deflection path of light, resulting in numerous ghosting images and severe image distortion. This makes it impossible to maintain stable imaging across a wide diopter adjustment range, resulting in a poor wearing experience for the specific user groups. That is to say, the visual system in the prior art has the problem that it is difficult to simultaneously achieve a large diopter adjustment range and stable imaging quality.

### SUMMARY

The main object of the present disclosure is to provide a visual system, so as to solve the problem in the prior art that it is difficult to simultaneously achieve a large diopter adjustment range and stable imaging quality in the visual system.

To achieve the above object, according to one aspect of the present disclosure, there is provided a visual system, comprising, in order from a human eye side to a display side along a direction of an optical axis of the visual system: a first element group comprising a first lens, a polarizer, a reflective polarizing element, and a quarter-wave plate, the first lens having a positive refractive power, a first side surface of the first lens being a convex surface, and a second side surface of the first lens being a planar surface; and a second element group being movable along the direction of the optical axis to approach or move away from the first element group, and comprising a second lens, a partially reflecting element, and a display, the second lens having a positive refractive power, a first side surface of the second lens being a convex surface, and a second side surface of the second lens being a convex surface; wherein a distance ΔL by which the second element group moves along the direction of the optical axis when the visual system moves from a +2D state to a −5D state, a center thickness CT1 of the first lens on the optical axis, a center thickness CTL of the polarizer on the optical axis, a center thickness CTR of the reflective polarizing element on the optical axis, and a center thickness CTQ of the quarter-wave plate on the optical axis satisfy: 0.89≤ΔL/(CT1+CTL+CTR+CTQ)≤1.34; and a center thickness CT2 of the second lens on the optical axis and an amount of change Δf in the effective focal length of the visual system when moving from the +2D state to the −5D state satisfy: 1.59≤CT2/Δf≤2.19.

According to another aspect of the present disclosure, there is provided a visual system, comprising, in order from a human eye side to a display side along a direction of an optical axis of the visual system: a first element group comprising a first lens, a polarizer, a reflective polarizing element, and a quarter-wave plate, the first lens having a positive refractive power, a first side surface of the first lens being a convex surface, and a second side surface of the first lens being a planar surface; and a second element group being movable along the direction of the optical axis to approach or move away from the first element group, and comprising a second lens, a partially reflecting element, and a display, the second lens having a positive refractive power, a first side surface of the second lens being a convex surface, and a second side surface of the second lens being a convex surface; wherein a distance ΔL by which the second element group moves along the direction of the optical axis when the visual system moves from a +2D state to a −5D state, a radius of curvature R1 of the first side surface of the first lens, and a radius of curvature R3 of the first side surface of the second lens satisfy: 2.14 mm≤ΔL×(R1/R3)≤3.00 mm; and a center thickness CT2 of the second lens on the optical axis and an amount of change Δf in the effective focal length of the visual system when moving from the +2D state to the −5D state satisfy: 1.59≤CT2/Δf≤2.19.

Further, a radius of curvature R3 of the first side surface of the second lens, a radius of curvature R4 of the second side surface of the second lens, and an air spacing T12m on the optical axis between the second side surface of the first lens and the first side surface of the second lens in the +2D state of the visual system satisfy: 1.07≤(R3+R4)/T12m≤10.70.

Further, a radius of curvature R1 of the first side surface of the first lens and a distance TDn on the optical axis from the first side surface of the first lens to the second side surface of the second lens in the −5D state of the visual system satisfy: 5.21≤R1/TDn≤6.85.

Further, an effective focal length f2 of the second lens, an effective focal length fm of the visual system in the +2D state, and an effective focal length fn of the visual system in the −5D state satisfy: 2.23≤f2/(fm+fn)≤2.52.

Further, a combined focal length fz of the first lens, the polarizer, the reflective polarizing element and the quarter-wave plate, and a distance TDm on the optical axis from the first side surface of the first lens to the second side surface of the second lens in the +2D state of the visual system satisfy: 7.78≤fz/TDm≤10.07.

Further, an effective focal length f1 of the first lens, an air spacing T12m on the optical axis between the second side surface of the first lens and the first side surface of the second lens in the +2D state of the visual system, and an air spacing T12n on the optical axis between the second side surface of the first lens and the first side surface of the second lens in the −5D state of the visual system satisfy: 8.28≤f1/(T12m+T12n)≤8.93.

Further, an effective focal length fn of the visual system in the −5D state, and the distance ΔL by which the second element group moves along the direction of the optical axis when the visual system moves from the +2D state to the −5D state satisfy: 7.15≤fn/ΔL≤7.65.

Further, the amount of change Δf in the effective focal length of the visual system when moving from the +2D state to the −5D state, a refractive index N1 of the first lens, and a refractive index N2 of the second lens satisfy: 6.62 mm≤Δf×(N1×N2)≤7.06 mm.

Further, an air spacing T12m on the optical axis between the second side surface of the first lens and the first side surface of the second lens in the +2D state of the visual system, a center thickness CT1 of the first lens on the optical axis, and a center thickness CT2 of the second lens on the optical axis satisfy: 1.27≤T12m/(CT1+CT2)≤2.02.

Further, an effective focal length fn of the visual system in the −5D state, and an air spacing T12n on the optical axis between the second side surface of the first lens and the first side surface of the second lens in the −5D state of the visual system satisfy: 3.28≤fn/T12n≤3.72.

Further, the distance ΔL by which the second element group moves along the direction of the optical axis when the visual system moves from the +2D state to the −5D state, a radius of curvature R1 of the first side surface of the first lens, and a radius of curvature R3 of the first side surface of the second lens satisfy: 2.14 mm≤ΔL×(R1/R3)≤3.00 mm.

Further, an effective focal length f2 of the second lens, a refractive index N2 of the second lens, and an effective focal length fm of the visual system in the +2D state satisfy: 2.79≤(f2/N2)/fm≤3.17.

Further, a radius of curvature R4 of the second side surface of the second lens, a distance TDm on the optical axis from the first side surface of the first lens to the second side surface of the second lens in the +2D state of the visual system, and a distance TDn on the optical axis from the first side surface of the first lens to the second side surface of the second lens in the −5D state of the visual system satisfy: −3.78≤R4/(TDm+TDn)≤−3.45.

Further, a distance TDm on the optical axis from the first side surface of the first lens to the second side surface of the second lens in the +2D state of the visual system, an effective focal length f1 of the first lens, and a dispersion coefficient V1 of the first lens satisfy: 5.53≤TDm/(f1/V1)≤7.24.

By applying the technical solution of the present application, the visual system comprises a first element group and a second element group in order from the human eye side to the display side along the direction of the optical axis of the visual system; the first element group comprises a first lens, a polarizer, a reflective polarizing element, and a quarter-wave plate, the first lens has a positive refractive power, a first side surface of the first lens is a convex surface, and a second side surface of the first lens is a planar surface; and the second element group is movable along the direction of the optical axis to approach or move away from the first element group, and comprises a second lens, a partially reflecting element, and a display, the second lens has a positive refractive power, a first side surface of the second lens is a convex surface, and a second side surface of the second lens is a convex surface; wherein a distance ΔL by which the second element group moves along the direction of the optical axis when the visual system moves from a +2D state to a −5D state, a center thickness CT1 of the first lens on the optical axis, a center thickness CTL of the polarizer on the optical axis, a center thickness CTR of the reflective polarizing element on the optical axis, and a center thickness CTQ of the quarter-wave plate on the optical axis satisfy: 0.89≤ΔL/(CT1+CTL+CTR+CTQ)≤1.34; and a center thickness CT2 of the second lens on the optical axis and an amount of change Δf in the effective focal length of the visual system when moving from the +2D state to the −5D state satisfy: 1.59≤CT2/Δf≤2.19.

By reasonably configuring the visual system to control 0.89≤ΔL/(CT1+CTL+CTR+CTQ)≤1.34 and 1.59≤CT2/Δf≤2.19, the movement accuracy and mechanical reliability of the second element group are balanced, thereby ensuring smooth and stable zooming actions, suppressing aberrations caused by excessive lens displacement, and avoiding image quality degradation. It is also possible to avoid the chromatic aberration or distortion caused by excessive refraction of light, and avoid material waste and weight increase caused by an excessively thick second lens, which balances optical performance and manufacturing cost, thereby ensuring that the visual system is efficient, stable, and lightweight during zooming, and making it suitable for mass production of consumer-grade VR devices.

### BRIEF DESCRIPTION OF THE DRAWINGS

The drawings constituting a part of the present application are used to provide a further understanding of the present disclosure, and the exemplary embodiments of the present disclosure and description thereof are used to explain the present application, and do not constitute an improper limitation of the present disclosure. In the drawings:

FIG. 1 shows a schematic structural diagram of a visual system according to Embodiment 1 of the present disclosure when it is in a first state;

FIG. 2 shows a schematic structural diagram of the visual system according to Embodiment 1 of the present disclosure when it is in a second state;

FIG. 3 shows an MTF (Modulation Transfer Function) curve diagram of the visual system according to Embodiment 1 of the present disclosure when it is in the first state;

FIG. 4 shows an MTF curve diagram of the visual system according to Embodiment 1 of the present disclosure when it is in the second state;

FIG. 5 shows a schematic structural diagram of a visual system according to Embodiment 2 of the present disclosure when it is in a first state;

FIG. 6 shows a schematic structural diagram of the visual system according to Embodiment 2 of the present disclosure when it is in a second state;

FIG. 7 shows an MTF curve diagram of the visual system according to Embodiment 2 of the present disclosure when it is in the first state;

FIG. 8 shows an MTF curve diagram of the visual system according to Embodiment 2 of the present disclosure when it is in the second state;

FIG. 9 shows a schematic structural diagram of a visual system according to Embodiment 3 of the present disclosure when it is in a first state;

FIG. 10 shows a schematic structural diagram of the visual system according to Embodiment 3 of the present disclosure when it is in a second state;

FIG. 11 shows an MTF curve diagram of the visual system according to Embodiment 3 of the present disclosure when it is in the first state;

FIG. 12 shows an MTF curve diagram of the visual system according to Embodiment 3 of the present disclosure when it is in the second state;

FIG. 13 shows a schematic structural diagram of a visual system according to Embodiment 4 of the present disclosure when it is in a first state;

FIG. 14 shows a schematic structural diagram of the visual system according to Embodiment 4 of the present disclosure when it is in a second state;

FIG. 15 shows an MTF curve diagram of the visual system according to Embodiment 4 of the present disclosure when it is in the first state; and

FIG. 16 shows an MTF curve diagram of the visual system according to Embodiment 4 of the present disclosure when it is in the second state.

The above-mentioned figures includes the following reference signs:

G1, first element group; G2, second element group; STO, stop; E1, first lens; LP, polarizer; RP, reflective polarizing element; QWP, quarter-wave plate; E2, second lens; BS, partially reflecting element; and IMG, image plane.

### DETAILED DESCRIPTION

It should be noted that, in the case of no conflict, the embodiments in the present application and the features in the embodiments may be combined with each other. The present disclosure will be described in detail below in conjunction with the embodiments with reference to the drawings.

It should be pointed out that, unless otherwise specified, all technical and scientific terms used in the present application have the same meanings as those commonly understood by those of ordinary skill in the field to which the present application belongs.

In the present disclosure, unless otherwise specified, directional words used, such as “up, down, top and bottom”, usually refer to the directions shown in the drawings, or to the components themselves in the vertical, perpendicular or gravity direction; similarly, for ease of understanding and description, “inside and outside” refer to the inside and outside relative to the outline of each component itself, but the above directional words are not used to limit the present disclosure.

It should be noted that in this specification, the expressions of “first”, “second”, “third” etc. are only used to distinguish one feature from another feature, and do not indicate any limitation on the feature. Therefore, without departing from the teachings of the present application, a first lens discussed below may also be referred to as a second lens or a third lens.

In the drawings, for convenience of explanation, the thickness, size, and shape of the lens have been slightly exaggerated. Specifically, the shapes of spherical or aspherical surfaces shown in the drawings are shown by way of example. That is, the shapes of the spherical or aspherical surfaces are not limited to those shown in the drawings. The drawings are only examples and are not drawn strictly to scale.

Herein, a paraxial region refers to a region near an optical axis. If a lens surface is a convex surface and the position of the convex surface is not defined, then it means that the lens surface is convex at least in the paraxial region; and if a lens surface is a concave surface and the position of the concave surface is not defined, then it means that the lens surface is concave at least in the paraxial region. The surface shape in the paraxial region can be determined according to a determination method commonly used by those skilled in the art, namely, using a positive or negative R value (R refers to the radius of curvature of the paraxial region, typically the R value in the lens data in optical software) to determine whether the surface shape is concave or convex. For a human eye side surface, when the R value is positive, it is determined as a convex surface, and when the R value is negative, it is determined as a concave surface; for a display side surface, when the R value is positive, it is determined as a concave surface, and when the R value is negative, it is determined as a convex surface.

To solve the problem in the prior art that it is difficult to achieve both a large diopter adjustment range and stable imaging quality in the visual system, the present disclosure provides a visual system.

### First Implementation

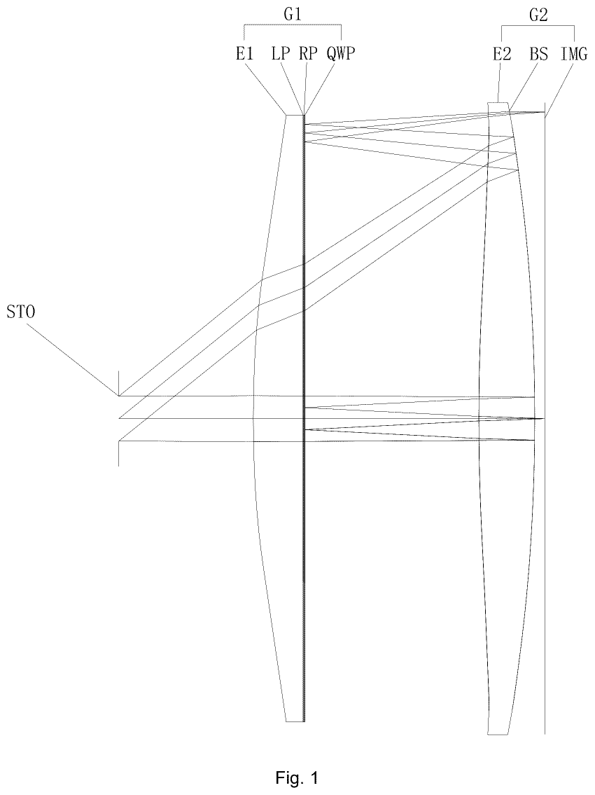

As shown in FIGS. 1 to 16, a visual system includes a first element group and a second element group in order from a human eye side to a display side along the direction of an optical axis of the visual system; the first element group includes a first lens, a polarizer, a reflective polarizing element, and a quarter-wave plate, the first lens has a positive refractive power, a first side surface of the first lens is a convex surface, and a second side surface of the first lens is a planar surface; and the second element group is movable along the direction of the optical axis to approach or move away from the first element group, and includes a second lens, a partially reflecting element, and a display, the second lens has a positive refractive power, a first side surface of the second lens is a convex surface, and a second side surface of the second lens is a convex surface; wherein a distance ΔL by which the second element group moves along the direction of the optical axis when the visual system moves from a +2D state to a −5D state, a center thickness CT1 of the first lens on the optical axis, a center thickness CTL of the polarizer on the optical axis, a center thickness CTR of the reflective polarizing element on the optical axis, and a center thickness CTQ of the quarter-wave plate on the optical axis satisfy: 0.89≤ΔL/(CT1+CTL+CTR+CTQ)≤1.34; and a center thickness CT2 of the second lens on the optical axis and an amount of change Δf in the effective focal length of the visual system when moving from the +2D state to the −5D state satisfy: 1.59≤CT2/Δf≤2.19.

By reasonably configuring the visual system to control 0.89≤ΔL/(CT1+CTL+CTR+CTQ)≤1.34 and 1.59≤CT2/Δf≤2.19, the movement accuracy and mechanical reliability of the second element group are balanced, thereby ensuring smooth and stable zooming actions, suppressing aberrations caused by excessive lens displacement, and avoiding image quality degradation. It is also possible to avoid the chromatic aberration or distortion caused by excessive refraction of light, and avoid material waste and weight increase caused by an excessively thick second lens, which balances optical performance and manufacturing cost, thereby ensuring that the visual system is efficient, stable, and lightweight during zooming, and making it suitable for mass production of consumer-grade VR devices.

In this implementation, a radius of curvature R3 of the first side surface of the second lens, a radius of curvature R4 of the second side surface of the second lens, and an air spacing T12m on the optical axis between the second side surface of the first lens and the first side surface of the second lens in the +2D state of the visual system satisfy: 1.07≤(R3+R4)/T12m≤10.70. By limiting (R3+R4)/T12m to be in a reasonable range, the refractive power distribution of the second lens can be controlled. The curvature design of the second lens can synergistically compensate for spherical aberration and field curvature introduced by zoom (change in T12m), thereby avoiding image edge blur or distortion. It can also reduce the asymmetry of light deflection and lower the risks of chromatic aberration and astigmatism.

In this implementation, a radius of curvature R1 of the first side surface of the first lens and a distance TDn on the optical axis from the first side surface of the first lens to the second side surface of the second lens in the −5D state of the visual system satisfy: 5.21≤R1/TDn≤6.85. By limiting R1/TDn to be in a reasonable range, the incident angle of light is balanced to avoid excessive divergence or convergence of light caused by excessive or insufficient curvature of the first lens surface, so that the spherical aberration and field curvature are effectively reduced, ensuring image clarity throughout the entire image, especially at the edges.

In this implementation, an effective focal length f2 of the second lens, an effective focal length fm of the visual system in the +2D state, and an effective focal length fn of the visual system in the −5D state satisfy: 2.23≤f2/(fm+fn)≤2.52. By limiting f2/(fm+fn) to be in a reasonable range, the influence of changes in the relative position of the lenses on the polarization state can be reduced, thereby reducing the interference of stray light, avoiding ghosting, and improving image contrast and the display quality of dynamic scenarios. It also helps reduce distortion and chromatic aberration caused by focal length changes, improving image clarity at different diopters.

In this implementation, a combined focal length fz of the first lens, the polarizer, the reflective polarizing element and the quarter-wave plate, and a distance TDm on the optical axis from the first side surface of the first lens to the second side surface of the second lens in the +2D state of the visual system satisfy: 7.78≤fz/TDm≤10.07. The positions of the reflective polarizing element and the quarter-wave plate are closely related to the focal length. By limiting fz/TDm to be in a reasonable range, the operating angle of the polarizer can be ensured to match the optical path, reducing ghosting (such as secondary reflected light) and color shift caused by polarization mismatch. It also reduces light leakage from non-imaging paths (such as stray light caused by the misaligned quarter-wave plate), thereby improving contrast and displaying dynamic scenarios smoothly.

In this implementation, an effective focal length f1 of the first lens, an air spacing T12m on the optical axis between the second side surface of the first lens and the first side surface of the second lens in the +2D state of the visual system, and an air spacing T12n on the optical axis between the second side surface of the first lens and the first side surface of the second lens in the −5D state of the visual system satisfy: 8.28≤f1/(T12m+T12n)≤8.93. By limiting f1/(T12m+T12n) to be in a reasonable range, optical element interference (such as polarizer friction or quarter-wave plate angle deviation) caused by the close distance between the first lens and the second lens is avoided, and necessary space can also be reserved for overall heat dissipation and circuit board layout.

In this implementation, an effective focal length fn of the visual system in the −5D state, and the distance ΔL by which the second element group moves along the direction of the optical axis when the visual system moves from the +2D state to the −5D state satisfy: 7.15≤fn/ΔL≤7.65. By limiting fn/ΔL to be in a reasonable range, the visual system achieves faster focusing, more stable image quality during zooming, and reduced blur or distortion. In addition, the energy required to drive lens movement is reduced, so that the visual system can adapt for application scenarios requiring rapid zoom (such as dynamic vision or real-time focusing during head movement). This also helps extend battery life and ensures a smooth user experience.

In this implementation, an amount of change Δf in the effective focal length of the visual system when moving from the +2D state to the −5D state, a refractive index N1 of the first lens, and a refractive index N2 of the second lens satisfy: 6.62 mm≤Δf×(N1×N2)≤7.06 mm. By limiting Δf×(N1×N2) to be in a reasonable range, chromatic aberration (such as lateral chromatic aberration) caused by wavelength-dependent refractive index differences can be reduced, thereby improving the color purity of imaging. This can also further reduce the lens thickness and the overall volume of the head-mounted display, reducing the wearing burden. It also avoids the problem of optical path redundancy or interference from additional optical elements (such as the polarizer) caused by improper material selection, simplifying the structural design of the system.

In this implementation, an air spacing T12m on the optical axis between the second side surface of the first lens and the first side surface of the second lens in the +2D state of the visual system, a center thickness CT1 of the first lens on the optical axis, and a center thickness CT2 of the second lens on the optical axis satisfy: 1.27≤T12m/(CT1+CT2)≤2.02. By limiting T12m/(CT1+CT2) to be in a reasonable range, the stability of the optical path is improved while ensuring adjustment flexibility, reducing light efficiency loss and ghosting issues, ensuring the optical performance of the visual system and improving imaging clarity. It can also avoid an increase in load on the nose bridge caused by excessive overall thickness, conforming to ergonomic design and improving the user's wearing experience.

In this implementation, an effective focal length fn of the visual system in the −5D state, and an air spacing T12n on the optical axis between the second side surface of the first lens and the first side surface of the second lens in the −5D state of the visual system satisfy: 3.28≤fn/T12n≤3.72. By limiting fn/T12n to be in a reasonable range, it helps optimize the thickness distribution of the first lens and the second lens, reducing distortion caused by the lens edges and improving the clarity of the field of view at the edges. It also reduces the occurrence of birefringence in the optical path, reduces color shift and artifacts caused by material or assembly errors, and improves image stability.

In this implementation, the distance ΔL by which the second element group moves along the direction of the optical axis when the visual system moves from the +2D state to the −5D state, a radius of curvature R1 of the first side surface of the first lens, and a radius of curvature R3 of the first side surface of the second lens satisfy: 2.14 mm≤ΔL×(R1/R3)≤3.00 mm. By limiting ΔL×(R1/R3) to be in a reasonable range, it is ensured that the first lens and the second lens can cover sufficient focal length changes when adjusting the diopter (from +2D to −5D) while avoiding optical distortion or ghosting problems caused by excessive magnitude of movement. It is also possible to avoid astigmatism caused by changes in the lens tilt angle, and balance the mechanical stroke and optical stability.

In this implementation, an effective focal length f2 of the second lens, a refractive index N2 of the second lens, and an effective focal length fm of the visual system in the +2D state satisfy: 2.79≤(f2/N2)/fm≤3.17. By limiting (f2/N2)/fm to be in a reasonable range, the synchronization of ocular convergence and accommodation between the first lens and the second lens can be optimized. The natural imaging mechanism of the human eye is simulated by dynamic focusing, reducing dizziness during prolonged use of VR devices. It also helps reduce light loss during multiple fold-back processes and is adapted to high-brightness screens (such as Micro LEDs), ensuring image brightness and detail representation.

In this implementation, a radius of curvature R4 of the second side surface of the second lens, a distance TDm on the optical axis from the first side surface of the first lens to the second side surface of the second lens in the +2D state of the visual system, and a distance TDn on the optical axis from the first side surface of the first lens to the second side surface of the second lens in the −5D state of the visual system satisfy: −3.78≤R4/(TDm+TDn)≤−3.45. By limiting R4/(TDm+TDn) to be in a reasonable range, the optical field distribution of the first lens and the second lens is balanced, reducing image curvature caused by field curvature while controlling distortion (such as barrel or pincushion distortion), ensuring that the image conforms to the natural field of view of the human eye. It also avoids the extra volume caused by an excessively large distance between the first lens and the second lens, while also avoiding optical path interference caused by an excessively small distance between the first lens and the second lens, thereby enhancing user experience comfort.

In this implementation, a distance TDm on the optical axis from the first side surface of the first lens to the second side surface of the second lens in the +2D state of the visual system, an effective focal length f1 of the first lens, and a dispersion coefficient V1 of the first lens satisfy: 5.53≤TDm/(f1/V1)≤7.24. By limiting TDm/(f1/V1) to be in a reasonable range, the dispersion effect of light in the folded optical path is reduced, improving edge image clarity. It also facilitates the lightweight and thin design of the whole machine, and helps the visual system maintain excellent optical performance over a wider diopter adjustment range.

### Second Implementation

As shown in FIGS. 1 to 16, a visual system includes, in order from a human eye side to a display side along the direction of an optical axis of the visual system; a first element group including a first lens, a polarizer, a reflective polarizing element, and a quarter-wave plate, the first lens having a positive refractive power, a first side surface of the first lens being a convex surface, and a second side surface of the first lens being a planar surface; and a second element group being movable along the direction of the optical axis to approach or move away from the first element group, and including a second lens, a partially reflecting element, and a display, the second lens having a positive refractive power, a first side surface of the second lens being a convex surface, and a second side surface of the second lens being a convex surface; wherein a distance ΔL by which the second element group moves along the direction of the optical axis when the visual system moves from a +2D state to a −5D state, a radius of curvature R1 of the first side surface of the first lens, and a radius of curvature R3 of the first side surface of the second lens satisfy: 2.14 mm≤ΔL×(R1/R3)≤3.00 mm; and a center thickness CT2 of the second lens on the optical axis and an amount of change Δf in the effective focal length of the visual system when moving from the +2D state to the −5D state satisfy: 1.59≤CT2/Δf≤2.19.

By reasonably configuring the visual system to control 2.14 mm≤ΔL×(R1/R3)≤3.00 mm and 1.59≤CT2/Δf≤2.19, it is ensured that the first lens and the second lens cover sufficient focal length variation during diopter adjustment (from +2D to −5D), while balancing the movement accuracy and mechanical reliability of the second element group. This ensures smooth and stable zooming actions, avoiding optical distortion or ghosting caused by excessive magnitude of movement, and astigmatism caused by changes in lens tilt angle. It is also possible to avoid the chromatic aberration or distortion caused by excessive refraction of light, and reduce material waste and weight increase caused by an excessively thick second lens, which balances optical performance and manufacturing cost, thereby ensuring that the visual system is efficient, stable, and lightweight during zooming, and making it suitable for mass production of consumer-grade VR devices.

This implementation may also include other parameter formulas in the first implementation, which will not be described in detail here.

In the present application, at least one of the first lens and the second lens has a lens surface which is an aspherical lens surface. The characteristic of an aspherical lens is that the curvature changes continuously from the center of the lens to the periphery of the lens. Unlike a spherical lens having a constant curvature from the center of the lens to the periphery of the lens, the aspherical lens has a better curvature radius characteristic, and has the advantages of ameliorating distortion aberration and ameliorating astigmatism aberration. After the aspherical lens is adopted, the aberrations that occur during imaging can be eliminated as much as possible, thereby improving the imaging quality.

However, it should be understood by those skilled in the art that the number of lenses constituting the visual system can be changed without departing from the technical solution claimed in the present application, to obtain respective results and advantages described in this specification. For example, although two lens sheets have been described in the implementations as an example, the visual system is not limited to including two lens sheets. If necessary, the visual system may also include another number of lenses.

It should be noted that the movement of the second element group of the visual system toward or away from the first element group along the optical axis causes a change in diopter. The diopter of the visual system is +2D in the first state and −5D in the second state. The first state indicates that the visual system is adapted for users with 200 degrees of hyperopia, and the second state indicates that the visual system is adapted for users with 500 degrees of myopia. The visual system further has states other than the first state and the second state, and the diopter of the visual system in these other states may range from +2D to −5D.

It should be noted that the first side refers to the side of a human eye, the second side refers to the side of a display, and the image plane is located on the display.

Embodiments of the visual system with specific surface profiles and parameters applicable to the above-mentioned implementations will be further described below with reference to the drawings.

It should be noted that any one example in Embodiments 1 to 4 to be described below is applicable to all embodiments of the present application.

### Embodiment 1

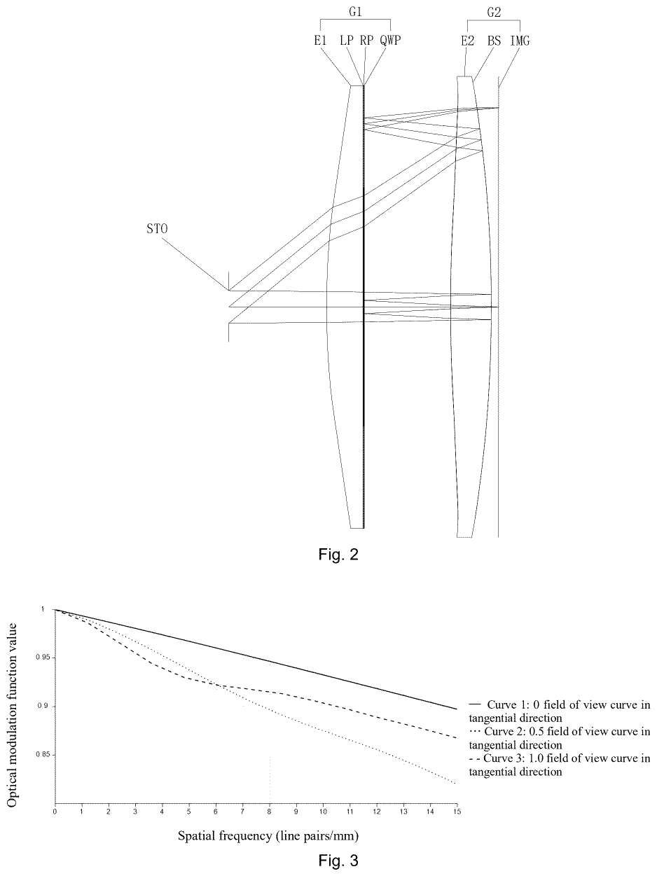

As shown in FIGS. 1 and 2, the structures of a visual system according to Embodiment 1 of the present application in a first state and a second state are illustrated, respectively.

As shown in FIGS. 1 and 2, the visual system includes a first element group G1 and a second element group G2 in sequence from a first side to a second side. The first element group G1 includes a first lens E1, a polarizer LP, a reflective polarizing element RP, and a quarter-wave plate QWP. The second element group G2 includes a second lens E2, a partially reflecting element BS, and a display. An image plane IMG is located on the display.

In this embodiment, the first lens has a positive refractive power, a first side surface of the first lens is a convex surface, and a second side surface of the first lens is a planar surface. The second lens has a positive refractive power, a first side surface of the second lens is a convex surface, and a second side surface of the second lens is a convex surface. The visual system further has a stop (aperture stop) STO located between the first side and the first element group. A first side surface of the polarizer is at least partially attached to (in contact with) the second side surface of the first lens. A second side surface of the polarizer and a first side surface of the reflective polarizing element are attached to (in contact with) each other. A second side surface of the reflective polarizing element and a first side surface of the quarter-wave plate are attached to (in contact with) each other, and the first side surface of the partially reflective element is at least partially attached to (in contact with) the second side surface of the second lens.

In this embodiment, light from the image plane IMG sequentially passes through the second lens E2 and the quarter-wave plate QWP before reaching the reflective polarizing element RP. After being reflected by the reflective polarizing element RP, the light again sequentially passes through the quarter-wave plate QWP and the second lens E2 before reaching the partially reflective element BS on the second side surface of the second lens. The light is reflected by the partially reflective element BS and then passes through the second lens E2, the quarter-wave plate QWP, the reflective polarizing element RP, the polarizer LP, and the first lens E1 before exiting.

Table 1 shows basic structural parameters of the visual system of Embodiment 1, where the units for the radius of curvature, thickness/distance, and effective focal length are all in millimeters (mm). In Table 1, light from the image plane IMG propagates from surface number 16 to the side of surface number 0. Refraction/reflection refers to the respective action of refraction or reflection of the light by the surface represented by that surface number. The surfaces represented by surface numbers 16 to 0 are, in order: the image plane, the second side surface of the second lens, the first side surface of the second lens, the second side surface of the quarter-wave plate, the first side surface of the quarter-wave plate (the second side surface of the reflective polarizing element), the second side surface of the quarter-wave plate, the first side surface of the second lens, the second side surface of the second lens (the first side surface of the partially reflective element), the first side surface of the second lens, the second side surface of the quarter-wave plate, the first side surface of the quarter-wave plate (the second side surface of the reflective polarizing element), the first side surface of the reflective polarizing element (the second side surface of the polarizer), the first side surface of the polarizer, the second side surface of the first lens, the first side surface of the first lens, a stop surface, and a virtual image plane.

TABLE 1

| Surface | | Surface | Radius of | | Refractive | Dispersion | Refraction/ | Cone |
|---|---|---|---|---|---|---|---|---|
| number | | type | curvature | Thickness | index | coefficient | reflection | coefficient |
| 0 | | Spherical | Infinite | D1 | | | Refraction | |
| 1 | Stop (STO) | Spherical | Infinite | 12.0000 | | | Refraction | |
| 2 | First lens (E1) | Aspherical | 120.5394 | 4.4355 | 1.537 | 55.71 | Refraction | 14.6841 |
| 3 | | Spherical | Infinite | 0.0000 | | | Refraction | |
| 4 | Polarizer (LP) | Spherical | Infinite | 0.0500 | 1.533 | 50.00 | Refraction | |
| 5 | Reflective polarizing | Spherical | Infinite | 0.0580 | 1.623 | 50.00 | Refraction | |
| | element (RP) | | | | | | | |
| 6 | Quarter-wave plate | Spherical | Infinite | 0.0510 | 1.533 | 50.00 | Refraction | |
| | (QWP) | | | | | | | |
| 7 | | Spherical | Infinite | D2 | | | Refraction | |
| 8 | Second lens (E2) | Aspherical | 210.5945 | 4.9866 | 1.547 | 56.30 | Refraction | 46.3547 |
| 9 | Partially reflective | Aspherical | −167.3860 | −4.9866 | 1.547 | 56.30 | Reflection | 1.0728 |
| | element (BS) | | | | | | | |
| 10 | | Aspherical | 210.5945 | D3 | | | Refraction | 46.3547 |
| 11 | | Spherical | Infinite | −0.0510 | 1.533 | 50.00 | Refraction | |
| 12 | Reflective polarizing | Spherical | Infinite | 0.0510 | 1.533 | 50.00 | Reflection | |
| | element (RP) | | | | | | | |
| 13 | | Spherical | Infinite | D4 | | | Refraction | |
| 14 | Second lens (E2) | Aspherical | 210.5945 | 4.9866 | 1.547 | 56.30 | Refraction | 46.3547 |
| 15 | | Aspherical | −167.3860 | 0.8944 | | | Refraction | 1.0728 |
| 16 | Image plane (IMG) | Spherical | Infinite | 0.0000 | | | Refraction | |

In Embodiment 1, the first side surface of the first lens E1, the first side surface of the second lens E2, and the second side surface of the second lens E2 are aspherical surfaces. The shape profiles of the respective aspherical surfaces can be defined by, but is not limited to, the following aspherical surface formula:

$$x = \frac{{ch}^{2}}{1 + \sqrt{1 - ( k + 1 ) {c}^{2} {h}^{2}}} + \sum {Aih}^{i} ; \qquad Formula ( 1 )$$

where x is a distance vector height from a vertex of the aspherical surface when the aspherical surface is at a height of h along the direction of the optical axis; c is paraxial curvature of the aspherical surface, c=1/R, that is, the paraxial curvature c is the reciprocal of the radius of curvature R in Table 1 above; k is a conic coefficient; and Ai is a correction coefficient of an i-th order of the aspherical surface. High-order coefficients A4, A6, A8, A10, A12, A14, A16, A18 and A20 of the aspherical surfaces that can be used in Embodiment 1 are given in Table 2 below.

TABLE 2

| Surface number | 2 | 14 | 15 |
|---|---|---|---|
| A4 | 8.5143E−06 | 2.4791E−06 | 1.8271E−06 |
| A6 | −4.6669E−08 | −2.8777E−08 | −9.5049E−09 |
| A8 | 1.7533E−10 | 5.6786E−11 | 1.6998E−11 |
| A10 | −3.5452E−13 | −3.9261E−14 | −9.9571E−15 |
| A12 | 2.8049E−16 | 1.1162E−18 | 0.0000E+00 |
| A14 | −5.6266E−20 | 2.3077E−21 | 0.0000E+00 |
| A16 | 0.0000E+00 | 0.0000E+00 | 0.0000E+00 |
| A18 | 0.0000E+00 | 0.0000E+00 | 0.0000E+00 |
| A20 | 0.0000E+00 | 0.0000E+00 | 0.0000E+00 |

In this embodiment, the movement of the second element group causes to change the diopter of the visual system, enabling a transition from the first state (+2D state) shown in FIG. 1 to the second state (−5D state) shown in FIG. 2. As shown in Table 3, some structural parameters of the visual system change, where D1 represents the value of the virtual image distance of the visual system in this embodiment, and D2, D3, and D4 represent the distances on the optical axis from the second side of the quarter-wave plate to the first side of the second lens. When D1, D2, D3, and D4 are positive values, a direction from the first side to the second side is indicated, and when they are negative values, a direction from the second side to the first side is indicated. The units for D1, D2, D3, and D4 are all in millimeters (mm).

TABLE 3

| | D1 | D2 | D3 | D4 |
|---|---|---|---|---|
| +2D state | 500.0000 | 15.5245 | −15.5245 | 15.5245 |
| −5D state | −200.0000 | 10.5667 | −10.5667 | 10.5667 |

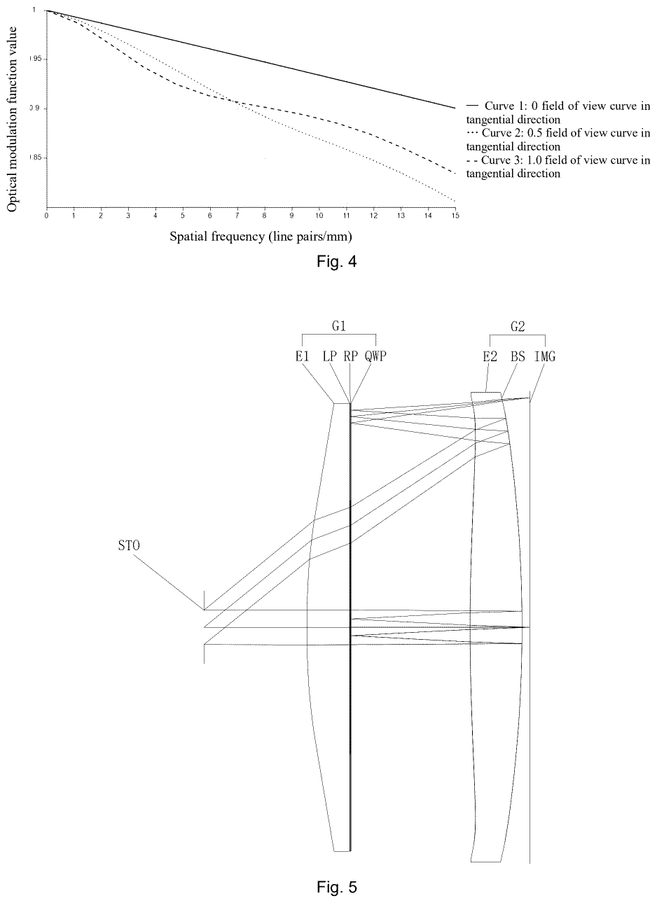

FIGS. 3 and 4 show MTF curve diagrams of the visual system of Embodiment 1 in the first state (+2D state) and the second state (−5D state), respectively. The MTF values under the light of each field of view are all above 0.8, exhibiting good imaging quality.

### Embodiment 2

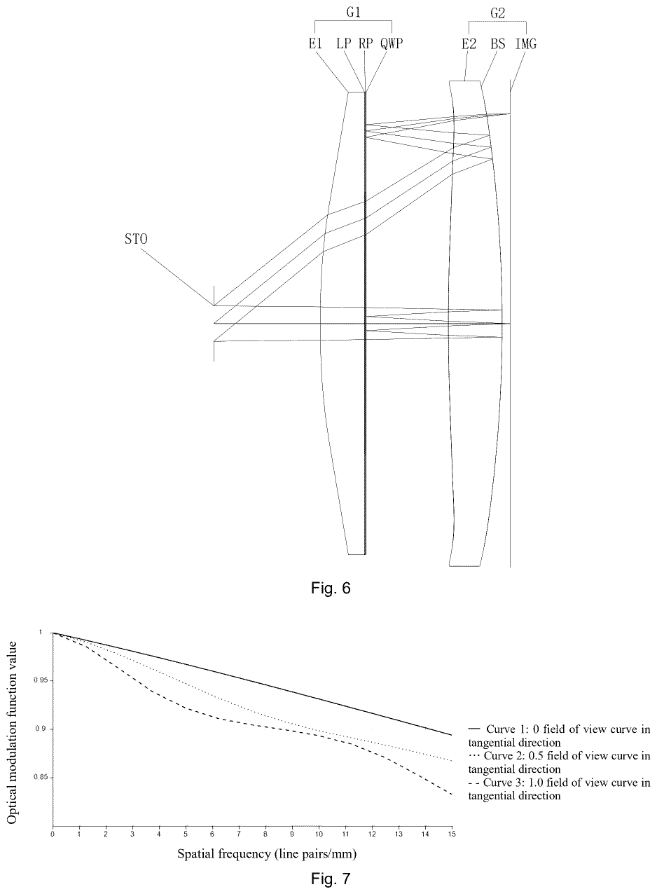

As shown in FIGS. 5 and 6, the structures of a visual system according to Embodiment 2 of the present application in a first state (+2D state) and a second state (−5D state) are illustrated, respectively.

As shown in FIGS. 5 and 6, the visual system includes a first element group G1 and a second element group G2 in sequence from a first side to a second side. The first element group G1 includes a first lens E1, a polarizer LP, a reflective polarizing element RP, and a quarter-wave plate QWP. The second element group G2 includes a second lens E2, a partially reflecting element BS, and a display. An image plane IMG is located on the display.

In this embodiment, the first lens has a positive refractive power, a first side surface of the first lens is a convex surface, and a second side surface of the first lens is a planar surface. The second lens has a positive refractive power, a first side surface of the second lens is a convex surface, and a second side surface of the second lens is a convex surface. The visual system further has a stop (aperture stop) STO located between the first side and the first element group. A first side surface of the polarizer is at least partially attached to (in contact with) the second side surface of the first lens. A second side surface of the polarizer and a first side surface of the reflective polarizing element are attached to (in contact with) each other. A second side surface of the reflective polarizing element and a first side surface of the quarter-wave plate are attached to (in contact with) each other, and the first side surface of the partially reflective element is at least partially attached to (in contact with) the second side surface of the second lens.

In this embodiment, light from the image plane IMG sequentially passes through the second lens E2 and the quarter-wave plate QWP before reaching the reflective polarizing element RP. After being reflected by the reflective polarizing element RP, the light again sequentially passes through the quarter-wave plate QWP and the second lens E2 before reaching the partially reflective element BS on the second side surface of the second lens. The light is reflected by the partially reflective element BS and then passes through the second lens E2, the quarter-wave plate QWP, the reflective polarizing element RP, the polarizer LP, and the first lens E1 before exiting.

Table 4 shows basic structural parameters of the visual system of Embodiment 2, where the units for the radius of curvature, thickness/distance, and effective focal length are all in millimeters (mm). In Table 4, light from the image plane IMG propagates from surface number 16 to the side of surface number 0. Refraction/reflection refers to the respective action of refraction or reflection of the light by the surface represented by that surface number. The surfaces represented by surface numbers 16 to 0 are, in order: the image plane, the second side surface of the second lens, the first side surface of the second lens, the second side surface of the quarter-wave plate, the first side surface of the quarter-wave plate (the second side surface of the reflective polarizing element), the second side surface of the quarter-wave plate, the first side surface of the second lens, the second side surface of the second lens (the first side surface of the partially reflective element), the first side surface of the second lens, the second side surface of the quarter-wave plate, the first side surface of the quarter-wave plate (the second side surface of the reflective polarizing element), the first side surface of the reflective polarizing element (the second side surface of the polarizer), the first side surface of the polarizer, the second side surface of the first lens, the first side surface of the first lens, a stop surface, and a virtual image plane.

TABLE 4

| Surface | | Surface | Radius of | | Refractive | Dispersion | Refraction/ | Cone |
|---|---|---|---|---|---|---|---|---|
| number | | type | curvature | Thickness | index | coefficient | reflection | coefficient |
| 0 | | Spherical | Infinite | D1 | | | Refraction | |
| 1 | Stop (STO) | Spherical | Infinite | 12.0000 | | | Refraction | |
| 2 | First lens (E1) | Aspherical | 106.8651 | 5.0000 | 1.547 | 56.30 | Refraction | 19.9078 |
| 3 | | Spherical | Infinite | 0.0000 | | | Refraction | |
| 4 | Polarizer (LP) | Spherical | Infinite | 0.0500 | 1.533 | 50.00 | Refraction | |
| 5 | Reflective polarizing | Spherical | Infinite | 0.0580 | 1.623 | 50.00 | Refraction | |
| | element (RP) | | | | | | | |
| 6 | Quarter-wave plate | Spherical | Infinite | 0.0510 | 1.533 | 50.00 | Refraction | |
| | (QWP) | | | | | | | |
| 7 | | Spherical | Infinite | D2 | | | Refraction | |
| 8 | Second lens (E2) | Aspherical | 203.4967 | 6.0698 | 1.547 | 56.30 | Refraction | 35.7810 |
| 9 | Partially reflective | Aspherical | −163.0980 | −6.0698 | 1.547 | 56.30 | Reflection | 22.0890 |
| | element (BS) | | | | | | | |
| 10 | | Aspherical | 203.4967 | D3 | | | Refraction | 35.7810 |
| 11 | | Spherical | Infinite | −0.0510 | 1.533 | 50.00 | Refraction | |
| 12 | Reflective polarizing | Spherical | Infinite | 0.0510 | 1.533 | 50.00 | Reflection | |
| | element (RP) | | | | | | | |
| 13 | | Spherical | Infinite | D4 | | | Refraction | |
| 14 | Second lens (E2) | Aspherical | 203.4967 | 6.0698 | 1.547 | 56.30 | Refraction | 35.7810 |
| 15 | | Aspherical | −163.0980 | 0.8944 | | | Refraction | 22.0890 |
| 16 | Image plane (IMG) | Spherical | Infinite | 0.0000 | | | Refraction | |

Table 5 shows higher-order coefficients of each aspherical lens surface that can be used in the embodiment, wherein the surface profile of each aspherical surface can be defined by Formula (1) given in Embodiment 1 described above. In this embodiment, the first side surface of the first lens, the first side surface of the second lens, and the second side surface of the second lens are all aspherical surfaces.

TABLE 5

| Surface number | 2 | 14 | 15 |
|---|---|---|---|
| A4 | 9.4069E−06 | −5.7697E−06 | −9.4096E−08 |
| A6 | −7.6396E−08 | 9.1957E−09 | 1.9166E−09 |
| A8 | 4.0434E−10 | −3.2656E−12 | 9.4631E−13 |
| A10 | −1.2892E−12 | −6.1694E−15 | −1.0142E−15 |
| A12 | 1.5579E−15 | −1.8894E−18 | −3.8759E−18 |
| A14 | 1.7572E−18 | −8.7148E−21 | 1.4701E−23 |
| A16 | −5.2893E−21 | −4.1942E−24 | −1.9017E−24 |
| A18 | 1.7511E−24 | 1.9487E−26 | 5.9373E−27 |
| A20 | 0.0000E+00 | 0.0000E+00 | 0.0000E+00 |

In this embodiment, the movement of the second element group causes to change the diopter of the visual system, enabling a transition from the first state (+2D state) shown in FIG. 5 to the second state (−5D state) shown in FIG. 6. As shown in Table 6, some structural parameters of the visual system change, where D1 represents the value of the virtual image distance of the visual system in this embodiment, and D2, D3, and D4 represent the distances on the optical axis from the second side of the quarter-wave plate to the first side of the second lens. When D1, D2, D3, and D4 are positive values, a direction from the first side to the second side is indicated, and when they are negative values, a direction from the second side to the first side is indicated. The units for D1, D2, D3, and D4 are all in millimeters (mm).

TABLE 6

| | D1 | D2 | D3 | D4 |
|---|---|---|---|---|
| +2D state | 500.0000 | 13.8768 | −13.8768 | 13.8768 |
| −5D state | −200.0000 | 9.2824 | −9.2824 | 9.2824 |

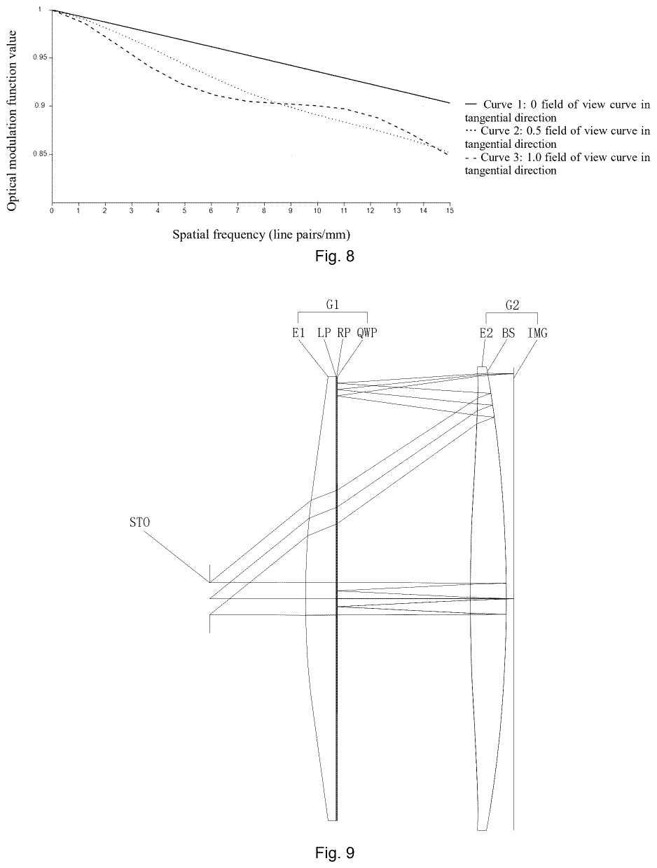

FIGS. 7 and 8 show MTF curve diagrams of the visual system of Embodiment 2 in the first state (+2D state) and the second state (−5D state), respectively. The MTF values under the light of each field of view are all above 0.8, exhibiting good imaging quality.

### Embodiment 3

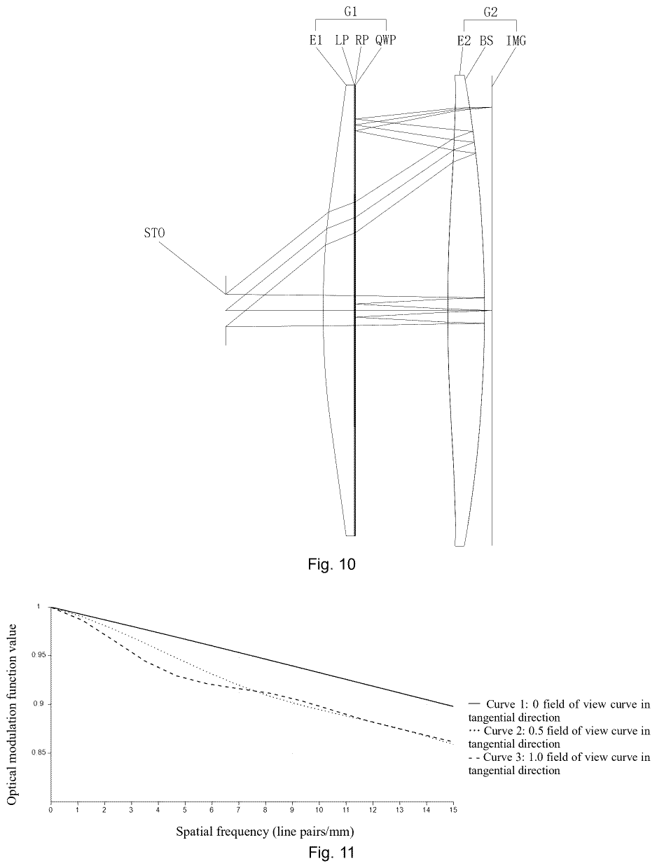

As shown in FIGS. 9 and 10, the structures of a visual system according to Embodiment 3 of the present application in a first state (+2D state) and a second state (−5D state) are illustrated, respectively.

As shown in FIGS. 9 and 10, the visual system includes a first element group G1 and a second element group G2 in sequence from a first side to a second side. The first element group G1 includes a first lens E1, a polarizer LP, a reflective polarizing element RP, and a quarter-wave plate QWP. The second element group G2 includes a second lens E2, a partially reflecting element BS, and a display. An image plane IMG is located on the display.

In this embodiment, the first lens has a positive refractive power, a first side surface of the first lens is a convex surface, and a second side surface of the first lens is a planar surface. The second lens has a positive refractive power, a first side surface of the second lens is a convex surface, and a second side surface of the second lens is a convex surface. The visual system further has a stop (aperture stop) STO located between the first side and the first element group. A first side surface of the polarizer is at least partially attached to (in contact with) the second side surface of the first lens. A second side surface of the polarizer and a first side surface of the reflective polarizing element are attached to (in contact with) each other. A second side surface of the reflective polarizing element and a first side surface of the quarter-wave plate are attached to (in contact with) each other, and the first side surface of the partially reflective element is at least partially attached to (in contact with) the second side surface of the second lens.

In this embodiment, light from the image plane IMG sequentially passes through the second lens E2 and the quarter-wave plate QWP before reaching the reflective polarizing element RP. After being reflected by the reflective polarizing element RP, the light again sequentially passes through the quarter-wave plate QWP and the second lens E2 before reaching the partially reflective element BS on the second side surface of the second lens. The light is reflected by the partially reflective element BS and then passes through the second lens E2, the quarter-wave plate QWP, the reflective polarizing element RP, the polarizer LP, and the first lens E1 before exiting.

Table 7 shows basic structural parameters of the visual system of Embodiment 3, where the units for the radius of curvature, thickness/distance, and effective focal length are all in millimeters (mm). In Table 7, light from the image plane IMG propagates from surface number 16 to the side of surface number 1. Refraction/reflection refers to the respective action of refraction or reflection of the light by the surface represented by that surface number. The surfaces represented by surface numbers 16 to 0 are, in order: the image plane, the second side surface of the second lens, the first side surface of the second lens, the second side surface of the quarter-wave plate, the first side surface of the quarter-wave plate (the second side surface of the reflective polarizing element), the second side surface of the quarter-wave plate, the first side surface of the second lens, the second side surface of the second lens (the first side surface of the partially reflective element), the first side surface of the second lens, the second side surface of the quarter-wave plate, the first side surface of the quarter-wave plate (the second side surface of the reflective polarizing element), the first side surface of the reflective polarizing element (the second side surface of the polarizer), the first side surface of the polarizer, the second side surface of the first lens, the first side surface of the first lens, a stop surface, and a virtual image plane.

TABLE 7

| Surface | | Surface | Radius of | | Refractive | Dispersion | Refraction/ | Cone |
|---|---|---|---|---|---|---|---|---|
| number | | type | curvature | Thickness | index | coefficient | reflection | coefficient |
| 0 | | Spherical | Infinite | D1 | | | Refraction | |
| 1 | Stop (STO) | Spherical | Infinite | 12.0000 | | | Refraction | |
| 2 | First lens (E1) | Aspherical | 135.8247 | 3.8000 | 1.537 | 55.71 | Refraction | −36.4062 |
| 3 | | Spherical | Infinite | 0.0000 | | | Refraction | |
| 4 | Polarizer (LP) | Spherical | Infinite | 0.0500 | 1.533 | 50.00 | Refraction | |
| 5 | Reflective polarizing | Spherical | Infinite | 0.0580 | 1.623 | 50.00 | Refraction | |
| | element (RP) | | | | | | | |
| 6 | Quarter-wave plate | Spherical | Infinite | 0.0510 | 1.533 | 50.00 | Refraction | |
| | (QWP) | | | | | | | |
| 7 | | Spherical | Infinite | D2 | | | Refraction | |
| 8 | Second lens (E2) | Aspherical | 334.7088 | 4.5000 | 1.537 | 55.71 | Refraction | 39.6131 |
| 9 | Partially reflective | Aspherical | −154.8338 | −4.5000 | 1.537 | 55.71 | Reflection | 8.6788 |
| | element (BS) | | | | | | | |
| 10 | | Aspherical | 334.7088 | D3 | | | Refraction | 39.6131 |
| 11 | | Spherical | Infinite | −0.0510 | 1.533 | 50.00 | Refraction | |
| 12 | Reflective polarizing | Spherical | Infinite | 0.0510 | 1.533 | 50.00 | Reflection | |
| | element (RP) | | | | | | | |
| 13 | | Spherical | Infinite | D4 | | | Refraction | |
| 14 | Second lens (E2) | Aspherical | 334.7088 | 4.5000 | 1.537 | 55.71 | Refraction | 39.6131 |
| 15 | | Aspherical | −154.8338 | 0.8944 | | | Refraction | 8.6788 |
| 16 | Image plane (IMG) | Spherical | Infinite | 0.0000 | | | Refraction | |

Table 8 shows higher-order coefficients of each aspherical lens surface that can be used in the embodiment, wherein the surface profile of each aspherical surface can be defined by Formula (1) given in Embodiment 1 described above. In this embodiment, the first side surface of the first lens, the first side surface of the second lens, and the second side surface of the second lens are all aspherical surfaces.

TABLE 8

| Surface number | 2 | 14 | 15 |
|---|---|---|---|
| A4 | 1.3340E−05 | 7.5759E−06 | 3.4110E−06 |
| A6 | −8.1810E−08 | −3.3174E−08 | −9.8839E−09 |
| A8 | 4.7616E−10 | 5.3968E−11 | 1.3183E−11 |
| A10 | −1.7514E−12 | −4.1529E−14 | −6.2455E−15 |
| A12 | 3.5242E−15 | 1.5519E−17 | 0.0000E+00 |
| A14 | −2.9535E−18 | −3.8140E−21 | 0.0000E+00 |
| A16 | 0.0000E+00 | 0.0000E+00 | 0.0000E+00 |
| A18 | 0.0000E+00 | 0.0000E+00 | 0.0000E+00 |
| A20 | 0.0000E+00 | 0.0000E+00 | 0.0000E+00 |

In this embodiment, the movement of the second element group causes to change the diopter of the visual system, enabling a transition from the first state (+2D state) shown in FIG. 9 to the second state (−5D state) shown in FIG. 10. As shown in Table 9, some structural parameters of the visual system change, where D1 represents the value of the virtual image distance of the visual system in this embodiment, and D2, D3, and D4 represent the distances on the optical axis from the second side of the quarter-wave plate to the first side of the second lens. When D1, D2, D3, and D4 are positive values, a direction from the first side to the second side is indicated, and when they are negative values, a direction from the second side to the first side is indicated. The units for D1, D2, D3, and D4 are all in millimeters (mm).

TABLE 9

| | D1 | D2 | D3 | D4 |
|---|---|---|---|---|
| +2D state | 500.0000 | 16.6466 | −16.6466 | 16.6466 |
| −5D state | −200.0000 | 11.3612 | −11.3612 | 11.3612 |

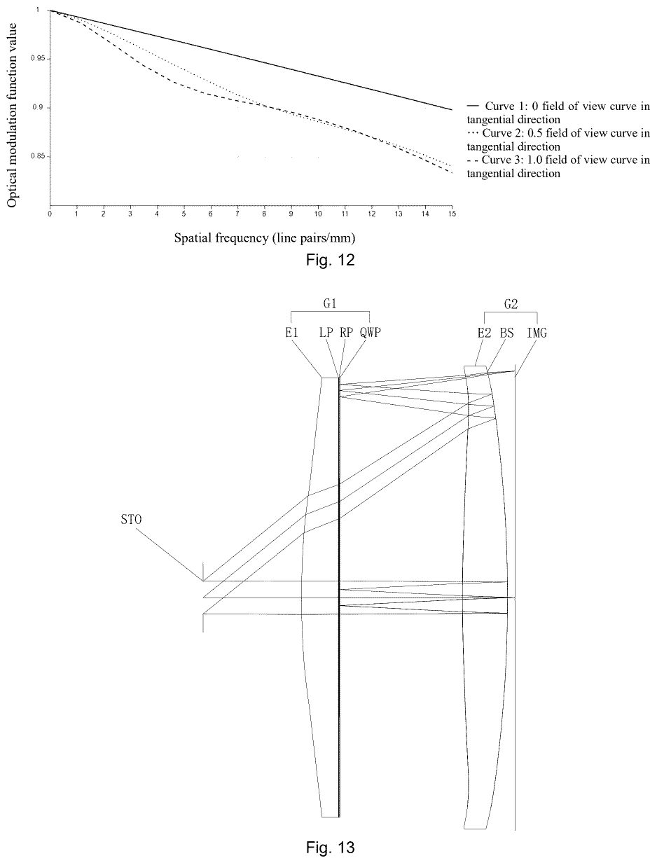

FIGS. 11 and 12 show MTF curve diagrams of the visual system of Embodiment 3 in the first state (+2D state) and the second state (−5D state), respectively. The MTF values under the light of each field of view are all above 0.8, exhibiting good imaging quality.

### Embodiment 4

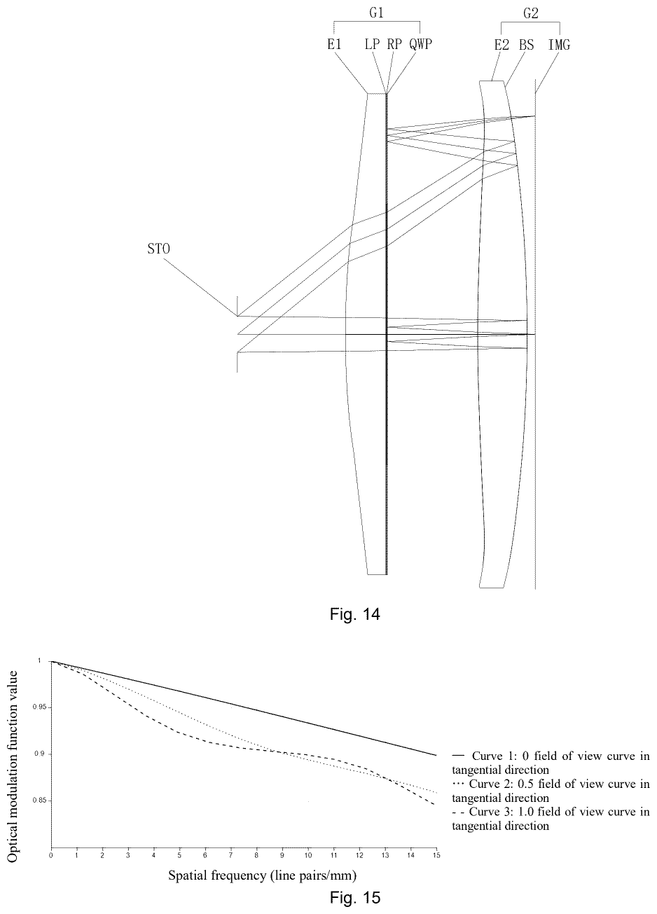

As shown in FIGS. 13 and 14, the structures of a visual system according to Embodiment 4 of the present application in a first state (+2D state) and a second state (−5D state) are illustrated, respectively.

As shown in FIGS. 13 and 14, the visual system includes a first element group G1 and a second element group G2 in sequence from a first side to a second side. The first element group G1 includes a first lens E1, a polarizer LP, a reflective polarizing element RP, and a quarter-wave plate QWP. The second element group G2 includes a second lens E2, a partially reflecting element BS, and a display. An image plane IMG is located on the display.

In this embodiment, the first lens has a positive refractive power, a first side surface of the first lens is a convex surface, and a second side surface of the first lens is a planar surface. The second lens has a positive refractive power, a first side surface of the second lens is a convex surface, and a second side surface of the second lens is a convex surface. The visual system further has a stop (aperture stop) STO located between the first side and the first element group. A first side surface of the polarizer is at least partially attached to (in contact with) the second side surface of the first lens. A second side surface of the polarizer and a first side surface of the reflective polarizing element are attached to (in contact with) each other. A second side surface of the reflective polarizing element and a first side surface of the quarter-wave plate are attached to (in contact with) each other, and the first side surface of the partially reflective element is at least partially attached to (in contact with) the second side surface of the second lens.

In this embodiment, light from the image plane IMG sequentially passes through the second lens E2 and the quarter-wave plate QWP before reaching the reflective polarizing element RP. After being reflected by the reflective polarizing element RP, the light again sequentially passes through the quarter-wave plate QWP and the second lens E2 before reaching the partially reflective element BS on the second side surface of the second lens. The light is reflected by the partially reflective element BS and then passes through the second lens E2, the quarter-wave plate QWP, the reflective polarizing element RP, the polarizer LP, and the first lens E1 before exiting.

Table 10 shows basic structural parameters of the visual system of Embodiment 4, where the units for the radius of curvature, thickness/distance, and effective focal length are all in millimeters (mm). In Table 10, light from the image plane IMG propagates from surface number 16 to the side of surface number 1. Refraction/reflection refers to the respective action of refraction or reflection of the light by the surface represented by that surface number. The surfaces represented by surface numbers 16 to 0 are, in order: the image plane, the second side surface of the second lens, the first side surface of the second lens, the second side surface of the quarter-wave plate, the first side surface of the quarter-wave plate (the second side surface of the reflective polarizing element), the second side surface of the quarter-wave plate, the first side surface of the second lens, the second side surface of the second lens (the first side surface of the partially reflective element), the first side surface of the second lens, the second side surface of the quarter-wave plate, the first side surface of the quarter-wave plate (the second side surface of the reflective polarizing element), the first side surface of the reflective polarizing element (the second side surface of the polarizer), the first side surface of the polarizer, the second side surface of the first lens, the first side surface of the first lens, a stop surface, and a virtual image plane.

TABLE 10

| Surface | | | Radius of | | Refractive | Dispersion | Refraction/ | Cone |
|---|---|---|---|---|---|---|---|---|
| number | | Surface type | curvature | Thickness | index | coefficient | reflection | coefficient |
| 0 | | Spherical | Infinite | D1 | | | Refraction | |
| 1 | Stop (STO) | Spherical | Infinite | 12.0000 | | | Refraction | |
| 2 | First lens (E1) | Aspherical | 114.7076 | 4.4938 | 1.547 | 56.30 | Refraction | 22.2070 |
| 3 | | Spherical | Infinite | 0.0000 | | | Refraction | |
| 4 | Polarizer (LP) | Spherical | Infinite | 0.0500 | 1.533 | 50.00 | Refraction | |
| 5 | Reflective polarizing | Spherical | Infinite | 0.0580 | 1.623 | 50.00 | Refraction | |
| | element (RP) | | | | | | | |
| 6 | Quarter-wave plate | Spherical | Infinite | 0.0510 | 1.533 | 50.00 | Refraction | |
| | (QWP) | | | | | | | |
| 7 | | Spherical | Infinite | D2 | | | Refraction | |
| 8 | Second lens (E2) | Aspherical | 187.4054 | 5.5000 | 1.537 | 55.71 | Refraction | 43.2855 |
| 9 | Partially reflective | Aspherical | −171.1993 | −5.5000 | 1.537 | 55.71 | Reflection | 20.0340 |
| | element (BS) | | | | | | | |
| 10 | | Aspherical | 187.4054 | D3 | | | Refraction | 43.2855 |
| 11 | | Spherical | Infinite | −0.0510 | 1.533 | 50.00 | Refraction | |
| 12 | Reflective polarizing | Spherical | Infinite | 0.0510 | 1.533 | 50.00 | Reflection | |
| | element (RP) | | | | | | | |
| 13 | | Spherical | Infinite | D4 | | | Refraction | |
| 14 | Second lens (E2) | Aspherical | 187.4054 | 5.5000 | 1.537 | 55.71 | Refraction | 43.2855 |
| 15 | | Aspherical | −171.1993 | 0.8944 | | | Refraction | 20.0340 |
| 16 | Image plane (IMG) | Spherical | Infinite | 0.0000 | | | Refraction | |

Table 11 shows higher-order coefficients of each aspherical lens surface that can be used in the embodiment, wherein the surface profile of each aspherical surface can be defined by Formula (1) given in Embodiment 1 described above. In this embodiment, the first side surface of the first lens, the first side surface of the second lens, and the second side surface of the second lens are all aspherical surfaces.

TABLE 11

| Surface number | 2 | 14 | 15 |
|---|---|---|---|
| A4 | 9.3242E−06 | −6.4962E−06 | −4.1904E−07 |
| A6 | −7.4332E−08 | 9.0578E−09 | 1.9971E−09 |
| A8 | 4.0671E−10 | −2.4633E−12 | 6.6200E−13 |
| A10 | −1.3835E−12 | −6.7914E−15 | −3.9865E−16 |
| A12 | 1.9181E−15 | −1.3212E−18 | −3.3045E−18 |
| A14 | 2.3531E−18 | −6.1896E−21 | −4.7899E−22 |
| A16 | −1.0580E−20 | −2.2297E−24 | −2.9618E−24 |
| A18 | 8.4920E−24 | 6.9969E−27 | 5.6044E−27 |
| A20 | 0.0000E+00 | 0.0000E+00 | 0.0000E+00 |

In this embodiment, the movement of the second element group causes to change the diopter of the visual system, enabling a transition from the first state (+2D state) shown in FIG. 13 to the second state (−5D state) shown in FIG. 14. As shown in Table 12, some structural parameters of the visual system change, where D1 represents the value of the virtual image distance of the visual system in this embodiment, and D2, D3, and D4 represent the distances on the optical axis from the second side of the quarter-wave plate to the first side of the second lens. When D1, D2, D3, and D4 are positive values, a direction from the first side to the second side is indicated, and when they are negative values, a direction from the second side to the first side is indicated. The units for D1, D2, D3, and D4 are all in millimeters (mm).

TABLE 12

| | D1 | D2 | D3 | D4 |
|---|---|---|---|---|
| +2D state | 500.0000 | 14.9529 | −14.9529 | 14.9529 |
| −5D state | −200.0000 | 10.0523 | −10.0523 | 10.0523 |

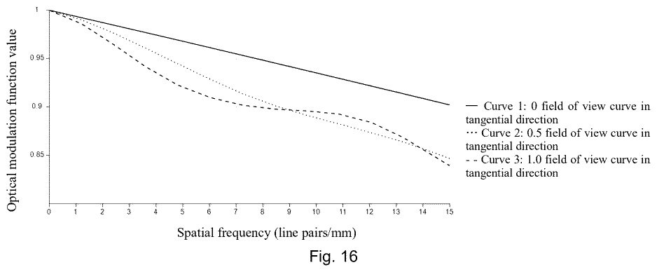

FIGS. 15 and 16 show MTF curve diagrams of the visual system of Embodiment 4 in the first state (+2D state) and the second state (−5D state), respectively. The MTF values under the light of each field of view are all above 0.8, exhibiting good imaging quality.

In summary, Embodiments 1 to 4 of the visual system satisfy the relationships shown in Table 13, respectively. The conditional expressions for the first state (+2D state) and the second state (−5D state) corresponding to each embodiment of the visual system have the same values.

TABLE 13

| | Embodiment | | | |
|---|---|---|---|---|
| Conditional | Embodi- | Embodi- | Embodi- | Embodi- |
| Expression | ment 1 | ment 2 | ment 3 | ment 4 |
| ΔL/(CT1 + CTL + | 1.08 | 0.89 | 1.34 | 1.05 |
| CTR + CTQ) | | | | |
| CT2/Δf | 1.70 | 2.19 | 1.59 | 1.85 |
| (R3 + R4)/T12m | 2.76 | 2.88 | 10.70 | 1.07 |
| R1/TDn | 5.98 | 5.21 | 6.85 | 5.68 |
| f2/(fm + fn) | 2.26 | 2.28 | 2.52 | 2.23 |
| fz/TDm | 8.94 | 7.78 | 10.07 | 8.35 |
| f1/(T12m + T12n) | 8.50 | 8.32 | 8.93 | 8.28 |
| fn/ΔL | 7.35 | 7.65 | 7.15 | 7.38 |
| Δf × (N1 × N2) (mm) | 6.97 | 6.62 | 6.68 | 7.06 |
| T12m/(CT1 + CT2) | 1.66 | 1.27 | 2.02 | 1.51 |
| fn/T12n | 3.40 | 3.72 | 3.28 | 3.54 |
| ΔL × (R1/R3) (mm) | 2.84 | 2.41 | 2.14 | 3.00 |
| (f2/N2)/fm | 2.81 | 2.84 | 3.17 | 2.79 |
| R4/(TDm + TDn) | −3.70 | −3.58 | −3.45 | −3.78 |
| TDm/(f1/V1) | 6.23 | 7.24 | 5.53 | 6.74 |

Table 14 shows the effective focal lengths and some parameters of each lens and each element group of the visual systems of Embodiments 1 to 4, in mm.

TABLE 14

| | Embodiment | | | |
|---|---|---|---|---|
| | Embodi- | Embodi- | Embodi- | Embodi- |
| Parameter | ment 1 | ment 2 | ment 3 | ment 4 |
| fm (mm) | 39.3629 | 37.9004 | 40.6168 | 39.1145 |
| fn (mm) | 36.4333 | 35.1335 | 37.7881 | 36.1450 |
| f1 (mm) | 224.4270 | 195.3480 | 252.8861 | 209.6839 |
| f2 (mm) | 171.2776 | 166.4727 | 197.7360 | 167.4742 |
| fz (mm) | 224.4270 | 195.3480 | 252.8861 | 209.6839 |
| TDm(mm) | 25.1056 | 25.1056 | 25.1056 | 25.1056 |
| TDn(mm) | 20.1479 | 20.5113 | 19.8202 | 20.2051 |
| T12m (mm) | 15.6835 | 14.0358 | 16.8056 | 15.1119 |
| T12n (mm) | 10.7257 | 9.4414 | 11.5202 | 10.2113 |
| ΔL (mm) | 4.9578 | 4.5944 | 5.2854 | 4.9006 |
| Δf (mm) | 2.9296 | 2.7669 | 2.8287 | 2.9695 |

It is apparent that the embodiments described above are only a part of the embodiments of the present application, and not all of them. All other embodiments obtained by those of ordinary skill in the art on the basis of the embodiments of the present disclosure without involving inventive skill should all be within the scope of protection of the present application.

It should be noted that the terms used herein are only for describing specific embodiments and are not intended to limit exemplary embodiments according to the present application. As used herein, unless the context clearly indicates otherwise, the singular form is also intended to include the plural form. In addition, it should be understood that when the terms “include” and/or “comprise” are used in this specification, it indicates the presence of features, steps, operations, devices, assemblies and/or combinations thereof.

It should be noted that the terms “first”, “second”, etc. in the specification and claims as well as the above drawings of the present application are used to distinguish similar objects, and are not necessarily used to describe a specific order or sequence. It should be understood that the data used in this way can be interchanged where appropriate, so that the implementations of the present application described herein can be implemented in an order other than that illustrated or described herein.

The above are only preferred embodiments of the present disclosure and are not intended to limit the present application. For those skilled in the art, the present application may have various modifications and changes. Any modifications, equivalent replacements, improvements, etc. made within the spirit and principle of the present disclosure shall be included in the scope of protection of the present application.

What is claimed is:

1. A visual system, comprising, in order from a human eye side to a display side along a direction of an optical axis of the visual system:
a first element group comprising a first lens, a polarizer, a reflective polarizing element, and a quarter-wave plate, the first lens having a positive refractive power, a first side surface of the first lens being a convex surface, and a second side surface of the first lens being a planar surface; and
a second element group being movable along the direction of the optical axis to approach or move away from the first element group, and comprising a second lens, a partially reflecting element, and a display, the second lens having a positive refractive power, a first side surface of the second lens being a convex surface, and a second side surface of the second lens being a convex surface;
wherein a distance ΔL by which the second element group moves along the direction of the optical axis when the visual system moves from a +2D state to a −5D state, a center thickness CT1 of the first lens on the optical axis, a center thickness CTL of the polarizer on the optical axis, a center thickness CTR of the reflective polarizing element on the optical axis, and a center thickness CTQ of the quarter-wave plate on the optical axis satisfy: 0.89≤ΔL/(CT1+CTL+CTR+CTQ)≤1.34; and
a center thickness CT2 of the second lens on the optical axis and an amount of change Δf in the effective focal length of the visual system when moving from the +2D state to the −5D state satisfy: 1.59≤CT2/Δf≤2.19.

2. The visual system according to claim 1, wherein a radius of curvature R3 of the first side surface of the second lens, a radius of curvature R4 of the second side surface of the second lens, and an air spacing T12m on the optical axis between the second side surface of the first lens and the first side surface of the second lens in the +2D state of the visual system satisfy: 1.07≤(R3+R4)/T12m≤10.70.

3. The visual system according to claim 1, wherein a radius of curvature R1 of the first side surface of the first lens and a distance TDn on the optical axis from the first side surface of the first lens to the second side surface of the second lens in the −5D state of the visual system satisfy: 5.21≤R1/TDn≤6.85.

4. The visual system according to claim 1, wherein an effective focal length f2 of the second lens, an effective focal length fm of the visual system in the +2D state, and an effective focal length fn of the visual system in the −5D state satisfy: 2.23≤f2/(fm+fn)≤2.52.

5. The visual system according to claim 1, wherein a combined focal length fz of the first lens, the polarizer, the reflective polarizing element and the quarter-wave plate, and a distance TDm on the optical axis from the first side surface of the first lens to the second side surface of the second lens in the +2D state of the visual system satisfy: 7.78≤fz/TDm≤10.07.

6. The visual system according to claim 1, wherein an effective focal length f1 of the first lens, an air spacing T12m on the optical axis between the second side surface of the first lens and the first side surface of the second lens in the +2D state of the visual system, and an air spacing T12n on the optical axis between the second side surface of the first lens and the first side surface of the second lens in the −5D state of the visual system satisfy: 8.28≤f1/(T12m+T12n)≤8.93.

7. The visual system according to claim 1, wherein an effective focal length fn of the visual system in the −5D state, and the distance ΔL by which the second element group moves along the direction of the optical axis when the visual system moves from the +2D state to the −5D state satisfy: 7.15≤fn/ΔL≤7.65.

8. The visual system according to claim 1, wherein the amount of change Δf in the effective focal length of the visual system when moving from the +2D state to the −5D state, a refractive index N1 of the first lens, and a refractive index N2 of the second lens satisfy: 6.62 mm≤Δf×(N1×N2)≤7.06 mm.

9. The visual system according to claim 1, wherein an air spacing T12m on the optical axis between the second side surface of the first lens and the first side surface of the second lens in the +2D state of the visual system, a center thickness CT1 of the first lens on the optical axis, and a center thickness CT2 of the second lens on the optical axis satisfy: 1.27≤T12m/(CT1+CT2)≤2.02.

10. The visual system according to claim 1, wherein an effective focal length fn of the visual system in the −5D state, and an air spacing T12n on the optical axis between the second side surface of the first lens and the first side surface of the second lens in the −5D state of the visual system satisfy: 3.28≤fn/T12n≤3.72.

11. The visual system according to claim 1, wherein the distance ΔL by which the second element group moves along the direction of the optical axis when the visual system moves from the +2D state to the −5D state, a radius of curvature R1 of the first side surface of the first lens, and a radius of curvature R3 of the first side surface of the second lens satisfy: 2.14 mm≤ΔL×(R1/R3)≤3.00 mm.

12. The visual system according to claim 1, wherein an effective focal length f2 of the second lens, a refractive index N2 of the second lens, and an effective focal length fm of the visual system in the +2D state satisfy: 2.79≤(f2/N2)/fm≤3.17.

13. The visual system according to claim 1, wherein a radius of curvature R4 of the second side surface of the second lens, a distance TDm on the optical axis from the first side surface of the first lens to the second side surface of the second lens in the +2D state of the visual system, and a distance TDn on the optical axis from the first side surface of the first lens to the second side surface of the second lens in the −5D state of the visual system satisfy: −3.78≤R4/(TDm+TDn)≤−3.45.

14. The visual system according to claim 1, wherein a distance TDm on the optical axis from the first side surface of the first lens to the second side surface of the second lens in the +2D state of the visual system, an effective focal length f1 of the first lens, and a dispersion coefficient V1 of the first lens satisfy: 5.53≤TDm/(f1/V1)≤7.24.

15. A visual system, comprising, in order from a human eye side to a display side along a direction of an optical axis of the visual system:
a first element group comprising a first lens, a polarizer, a reflective polarizing element, and a quarter-wave plate, the first lens having a positive refractive power, a first side surface of the first lens being a convex surface, and a second side surface of the first lens being a planar surface; and
a second element group being movable along the direction of the optical axis to approach or move away from the first element group, and comprising a second lens, a partially reflecting element, and a display, the second lens having a positive refractive power, a first side surface of the second lens being a convex surface, and a second side surface of the second lens being a convex surface;
wherein a distance ΔL by which the second element group moves along the direction of the optical axis when the visual system moves from a +2D state to a −5D state, a radius of curvature R1 of the first side surface of the first lens, and a radius of curvature R3 of the first side surface of the second lens satisfy: 2.14 mm≤ΔL×(R1/R3)≤3.00 mm; and
a center thickness CT2 of the second lens on the optical axis and an amount of change Δf in the effective focal length of the visual system when moving from the +2D state to the −5D state satisfy: 1.59≤CT2/Δf≤2.19.

16. The visual system according to claim 15, wherein the radius of curvature R3 of the first side surface of the second lens, a radius of curvature R4 of the second side surface of the second lens, and an air spacing T12m on the optical axis between the second side surface of the first lens and the first side surface of the second lens in the +2D state of the visual system satisfy: 1.07≤(R3+R4)/T12m≤10.70.

17. The visual system according to claim 15, wherein the radius of curvature R1 of the first side surface of the first lens and a distance TDn on the optical axis from the first side surface of the first lens to the second side surface of the second lens in the −5D state of the visual system satisfy: 5.21≤R1/TDn≤6.85.

18. The visual system according to claim 15, wherein an effective focal length f2 of the second lens, an effective focal length fm of the visual system in the +2D state, and an effective focal length fn of the visual system in the −5D state satisfy: 2.23≤f2/(fm+fn)≤2.52.

19. The visual system according to claim 15, wherein a combined focal length fz of the first lens, the polarizer, the reflective polarizing element and the quarter-wave plate, and a distance TDm on the optical axis from the first side surface of the first lens to the second side surface of the second lens in the +2D state of the visual system satisfy: 7.78≤fz/TDm≤10.07.

20. The visual system according to claim 15, wherein an effective focal length f1 of the first lens, an air spacing T12m on the optical axis between the second side surface of the first lens and the first side surface of the second lens in the +2D state of the visual system, and an air spacing T12n on the optical axis between the second side surface of the first lens and the first side surface of the second lens in the −5D state of the visual system satisfy: 8.28≤f1/(T12m+T12n)≤8.93.
